(19) United States
(12) Patent Application Publication
(10) Pub. No.: US 2014/0232503 A1
(43) Pub. Date: Aug. 21, 2014

(54) FLEXIBLE SUBSTRATE INDUCTIVE APPARATUS AND METHODS

(71) Applicant: PULSE ELECTRONICS, INC., (US)

(72) Inventor: Aurelio Gutierrez, Bonita, CA (US)

(21) Appl. No.: 13/835,129

(22) Filed: Mar. 15, 2013

Related U.S. Application Data
(60) Provisional application No. 61/767,705, filed on Feb. 21, 2013.

(51) Int. Cl. H01F 27/28; H01F 41/02; H01F 41/04

(52) U.S. Cl. CPC H01F 27/2804; H01F 41/041; H01F 41/02
USPC 336/200; 29/602.1

(57) ABSTRACT

Flexible substrate inductive apparatus and methods for manufacturing, and utilizing, the same. In one embodiment, the flexible substrate inductive device is formed from a planar surface and has a plurality of conductive traces printed thereon. These conductive traces can be used as, for example, an inductor or when formed using multiple windings such as a primary and a secondary winding, as a transformer. The use of the flexible substrate as an inductive device is accomplished via the incorporation of slots within the substrate which allows the conductive traces to be formed and routed around, for example, a magnetically permeable core. Methods of using and manufacturing the aforementioned flexible substrate inductive devices are also disclosed.

### PRIORITY

This application claims the benefit of priority to co-owned U.S. Provisional Patent Application Ser. No. 61/767,705 of the same title filed Feb. 21, 2013, the contents of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. TECHNOLOGICAL FIELD

The present disclosure relates generally to inductive devices, and more particularly in one exemplary aspect to flexible inductive apparatus having various desirable electrical and/or mechanical properties, and methods of utilizing and manufacturing the same.

### 2. DESCRIPTION OF RELATED TECHNOLOGY

A myriad of different configurations of inductors and inductive devices are known in the prior art. One common approach to the manufacture of efficient inductors and inductive devices is the use of a magnetically permeable toroidal core. Toroidal cores are very efficient at maintaining the magnetic flux of an inductive device constrained within the core itself. Typically, these cores (toroidal or not) are wound with one or more magnet wire windings, thereby forming an inductor or other type of inductive devices such as transformers.

Prior art inductors and inductive devices are exemplified in a wide variety of shapes and manufacturing configurations. See for example, U.S. Pat. No. 3,614,554 to Shield, et al. issued Oct. 19, 1971 and entitled “Miniaturized Thin Film Inductors for use in Integrated Circuits”; U.S. Pat. No. 4,253,231 to Nouet issued Mar. 3, 1981 and entitled “Method of making an inductive circuit incorporated in a planar circuit support member”; U.S. Pat. No. 4,547,961 to Bokil, et al. issued Oct. 22, 1985 and entitled “Method of manufacture of miniaturized transformer”; U.S. Pat. No. 4,847,986 to Meinel issued Jul. 18, 1989 and entitled “Method of making square toroid transformer for hybrid integrated circuit”; U.S. Pat. No. 5,055,816 to Altman, et al. issued Oct. 8, 1991 and entitled “Method for fabricating an electronic device”; U.S. Pat. No. 5,126,714 to Johnson issued Jun. 30, 1992 and entitled “Integrated circuit transformer”; U.S. Pat. No. 5,257,000 to Billings, et al. issued Oct. 26, 1993 and entitled “Circuit elements dependent on core inductance and fabrication thereof”; U.S. Pat. No. 5,487,214 to Walters issued Jan. 30, 1996 and entitled “Method of making a monolithic magnetic device with printed circuit interconnections”; U.S. Pat. No. 5,781,091 to Krone, et al. issued Jul. 14, 1998 and entitled “Electronic inductive device and method for manufacturing”; U.S. Pat. No. 6,440,750 to Feygenson, et al. issued Aug. 27, 2002 and entitled “Method of making integrated circuit having a micromagnetic device”; U.S. Pat. No. 6,445,271 to Johnson issued Sep. 3, 2002 and entitled “Three-dimensional micro-coils in planar substrates”; U.S. Patent Publication No. 20060176139 to Pleskach; et al. published Aug. 10, 2006 and entitled “Embedded toroidal inductor”; U.S. Patent Publication No. 20060290457 to Lee; et al. published Dec. 28, 2006 and entitled “Inductor embedded in substrate, manufacturing method thereof, micro device package, and manufacturing method of cap for micro device package”; U.S. Patent Publication No. 20070001796 to Waffenschmidt; et al. published Jan. 4, 2007 and entitled “Printed circuit board with integrated inductor”; and U.S. Patent Publication No. 20070216510 to Jeong; et al. published Sep. 20, 2007 and entitled “Inductor and method of forming the same”, the contents of each of the foregoing incorporated herein by reference in its entirety. Despite the automation of key tasks in traditional wire-wound inductive devices, certain tasks still require human labor resulting in increased costs due in part to ever increasing labor rates. For example, wires must be laid out, cut, and carefully terminated. Each of these processes has been heretofore impossible to implement using automated processes.

Accordingly, despite the broad variety of prior art inductor configurations, there is a salient need for inductive devices that are both: (1) low in cost to manufacture; and (2) offer improved and more consistent electrical performance over prior art inductive devices. Ideally such a solution would not only offer very low manufacturing cost and improved electrical performance for the inductor or inductive device, but also provide greater consistency between devices manufactured in mass production; i.e., by increasing consistency and reliability of performance by, for example, limiting opportunities for manufacturing errors of the device.

### SUMMARY

In a first aspect, a flexible substrate inductive apparatus is disclosed. In one embodiment, the flexible substrate inductive apparatus comprises a substrate having a plurality of traces printed thereon, the substrate being flexible so as to enable the plurality of traces to act as windings that are disposed about a ferrite core.

In another embodiment, the flexible substrate inductive apparatus includes a flexible polymer film having a plurality of conductive traces disposed thereon and a ferrite core. The flexible polymer film is shaped so that the plurality of conductive traces forms one or more windings. The ferrite core is disposed such that its use in combination with the one or more windings forms the flexible substrate inductive device.

In yet another embodiment, the flexible substrate inductive apparatus includes a flexible substrate having at least two rows of slots disposed therein and a ferrite core. The flexible substrate comprises a plurality of windings with a set of windings disposed about each of the rows of slots.

In another embodiment, the apparatus is constructed such that first and second windings have balanced performance. In one variant, the balanced performance is accomplished via the windings on the first and second sides of the substrate each having the same effective winding distance from the inserted core.

In a second aspect, electronic apparatus that utilize the aforementioned flexible substrate inductive apparatus is disclosed. In one embodiment, the electronic apparatus comprises an integrated connector module and the flexible substrate inductive apparatus contained therein offers electrical isolation between the line side and chip side of the integrated connector module.

In a third aspect, methods of manufacturing the aforementioned flexible substrate inductive apparatus are disclosed. In one embodiment, the method includes printing one or more conductive windings onto a two-dimensional flexible substrate; forming the two-dimensional flexible substrate into a three-dimensional form; and inserting a core portion into the three-dimensional flexible substrate form.

In a fourth aspect, methods of manufacturing the aforementioned electronic apparatus that utilizes a flexible substrate inductive apparatus are disclosed.

In a fifth aspect, methods of using the aforementioned flexible substrate inductive apparatus are disclosed.

### BRIEF DESCRIPTION OF THE DRAWINGS

The features, objectives, and advantages of the present disclosure will become more apparent from the detailed description set forth below when taken in conjunction with the drawings, wherein:

FIG. 1A is a plan view illustrating a first embodiment of a flexible substrate for use as an inductive device in accordance with the principles of the present disclosure.

FIG. 1B is a perspective view illustrating the flexible substrate illustrated in FIG. 1A.

FIG. 1C is a perspective view illustrating a first embodiment of a flexible substrate inductive device utilizing the substrate illustrated in FIGS. 1A-1B in accordance with the principles of the present disclosure.

FIG. 2A is a perspective view illustrating a second embodiment of a flexible substrate for use as an inductive device in accordance with the principles of the present disclosure.

FIG. 2B is a perspective view illustrating the flexible substrate illustrated in FIG. 2A formed prior to the insertion of a magnetic core.

FIG. 2C is a perspective view illustrating a second embodiment of a flexible substrate inductive device utilizing the substrate illustrated in FIGS. 2A-2B in accordance with the principles of the present disclosure.

FIG. 3A is a perspective view illustrating a third embodiment of a flexible substrate for use as an inductive device in accordance with the principles of the present disclosure.

FIG. 3B is a perspective view illustrating a third embodiment of a flexible substrate inductive device utilizing the substrate illustrated in FIG. 3A in accordance with the principles of the present disclosure.

FIG. 4A is a perspective view illustrating a fourth embodiment of a flexible substrate for use as an inductive device in accordance with the principles of the present disclosure.

FIG. 4B is a perspective view illustrating a fourth embodiment of a flexible substrate inductive device utilizing the substrate illustrated in FIG. 4A in accordance with the principles of the present disclosure.

FIG. 5 is a process flow diagram illustrating a first exemplary embodiment of the method for manufacturing a flexible substrate inductive device in accordance with the principles of the present disclosure.

All Figures disclosed herein are Copyright 2013 Pulse Electronics, Inc. All rights reserved.

### DETAILED DESCRIPTION OF EXEMPLARY EMBODIMENTS

Reference is now made to the drawings, wherein like numerals refer to like parts throughout.

As used herein, the terms “electrical component” and “electronic component” are used interchangeably and refer to components adapted to provide some electrical and/or signal conditioning function, including without limitation inductive reactors (“choke coils”), transformers, filters, transistors, gapped core toroids, inductors (coupled or otherwise), capacitors, resistors, operational amplifiers, and diodes, whether discrete components or integrated circuits, whether alone or in combination.

As used herein, the term “etching” or “engraving” refers without limitation to the process of removing material via the application of light energy (e.g. a laser) or via a chemical reduction process. Additionally, any etching process of print thin films previously deposited and/or the underlying substrate itself includes wet etching, and dry etching, among others. Etching can also be referred to as photo chemical milling, metal etching, chemical machining, or photo fabrication whether one sided or two sided etching. Additionally, etching can apply to either the positive or negative image, or both.

As used herein, the term “magnetically permeable” refers to any number of materials commonly used for forming inductive cores or similar components, including without limitation various formulations made from ferrite.

As used herein, the term “printing” refers without limitation to both printing using traditional print fluids as well as processes that include: digital printing such as thermal inkjet, piezo inkjet, micro piezo inkjet, bubble jet; analog printing technologies such as screen printing, gravure printing, flexo printing, engraving printing, pad printing, rotary printing, rotary screen printing, stencil printing and others; aerosol jetting including the use of a mist generator that atomizes a source material where the aerosol stream can then be refined and deposited (e.g. Optomec). Variations include maskless mesoscale materials deposition; fluid and material dispensing systems using auger, head over valve, piezo, valve, needle, screw, cavity, conformal coaters, and pumps. Printing also refers to micro contact printing, nano-imprint lithography, etching/engraving including on conductive foils, Laser Direct Structuring (LDS), and spray and stencil techniques whether one sided or two sided printing. Additionally, printing can refer to the separate process where the laser engraves, marks, or etches a substrate including LDS where a substrate is molded using an LDS-grade resin that can be laser activated (e.g. LPKF). Additionally, printing can apply to either the positive or negative image or both.

As used herein, the term “print fluids” refers without limitation to conductors, semiconductors, dielectrics, or insulators whether of an organic or inorganic nature. Print fluids can take the form of liquid, for solution, dispersion or suspension. For example, print fluids can be made from electrically conductive materials or particles with a metallic base (e.g. silver, copper, gold, aluminum, alloys and/or mixtures of these elements, micron or nano particles of these elements, and any other elements). Such print fluids include inks, pastes, polymers, or printable pastes and/or inks based on conductive polymers, conductive oxides, like iron oxide, ITO or aluminum zinc oxide, carbon nanotubes or graphene.

As used here, the term “seed printing” refers without limitation to conductive inks that can be used in the printing of seed layers for electroplating processes. Upon printing of a seed layer, an electroplating process (such as, for example, copper) can be deposited onto the printed layer.

As used herein, the terms “top”, “bottom”, “side”, “up”, “down” and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

### Overview

The present disclosure provides, inter glia, improved flexible substrate inductive apparatus and methods for manufacturing, and utilizing, the same.

In one exemplary embodiment, the flexible substrate inductive device is formed from a planar surface and has a plurality of conductive traces printed thereon. In addition to forming the windings of the flexible substrate inductive device, these printed surfaces can also embody additional design elements including capacitive and inductive elements. Furthermore, these printed traces can embody connections and terminations within the design itself without having to resort to being cut and connected directly to the connector pins thereby significantly reducing the wiring effort. Consequently, the number of manufacturing steps can be reduced and cost savings can be realized.

These conductive traces can be used as, for example, an inductor, or when formed using both a primary and a secondary winding as a transformer device. The use of a flexible substrate as an inductive device is accomplished via the incorporation of slots within the substrate which allows the conductive traces to be formed and routed around, for example, a magnetically permeable core. The flexible substrate inductive device has conductive traces formed on one or more layers of the substrate in order to accomplish the desired electrical function.

In one implementation, the conductive windings terminate at terminal interfaces that can be mated to any number of electronic devices including, for example a termination header for use with discrete magnetic electronics or alternatively as the magnetic electronics disposed within an integrated connector module.

In an alternative implementation, the flexible substrate is replaced by a rigid substrate with conductive windings printed thereon.

Methods of using and manufacturing the aforementioned substrate inductive devices (and host apparatus) are also disclosed.

### Exemplary Embodiments

Detailed descriptions of the various embodiments and variants of the apparatus and methods of the present disclosure are now provided. It will be appreciated that while the following discussion is cast in terms of a transformer, the present disclosure is not so limited and is in fact equally applicable to other inductive devices including, without limitation, inductors, choke coils, and the like. These and other applications would be readily apparent to one of ordinary skill given the present disclosure.

Additionally, while primarily discussed in the context of printing on a flexible substrate for fabrication of mechanically flexible electronics, it is appreciated that printing can also be performed on rigid substrates like glass and silicon, plastic or metals like ferrite as well. For example, a laser direct structuring (“LDS”) process can be applied to a three-dimensional molded (i.e. over-molded or injection molded) plastic substrate and a core can be subsequently inserted into this rigid structure. These flexible or rigid substrates may comprise, for example, polyethylene terephthalate (“PET”), polyethylene naphthalate (“PEN”), polycarbonate (“PC”), acrylonitrile butadiene styrene (“ABS”), as well as any high-density polyethylene (“HDPE”) and low-density polyethylene (“LDPE”) plastics.

### Improved Inductive Device—

Mass customization is the new frontier in manufacturing industries. Shorter runs driven by mass customization and resultant smaller lot sizes for traditional wire wound inductive devices required extensive setup and overhead costs (e.g. adjusting flyers, shields, guiding elements etc.). It can be claimed that is it not possible to face tomorrow's market requirements such as small lot sizes or high product flexibility, with current manufacturing approaches. This new approach for an improved inductive device allows for accurate wire placement, wire width, and wire gaps by using, for example, generalized printing techniques. These can be digitally constructed with each layout unique down to a single manufacturing unit. For example, the use of flexible computer-aided printing systems in manufacturing can be used to produce custom layouts item by item. These systems have advantages when combined with low costs from mass produced planar windings with the flexibility of individual customization. Consequently, the number of manufacturing steps can be reduced and flexibility around job design specification can be realized. Current trends in production technology are challenging for conventional winding methods. Different cars, for example, can require different coils sizes. Different network cards can require different winding geometries as bandwidth varies. At the core of this innovation is a tremendous increase in variety and customization without a corresponding increase in costs.

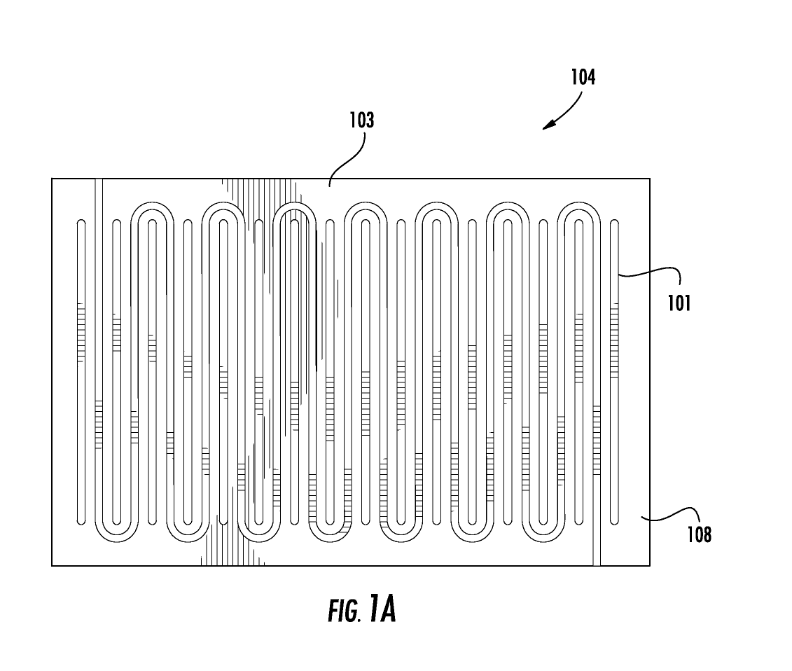

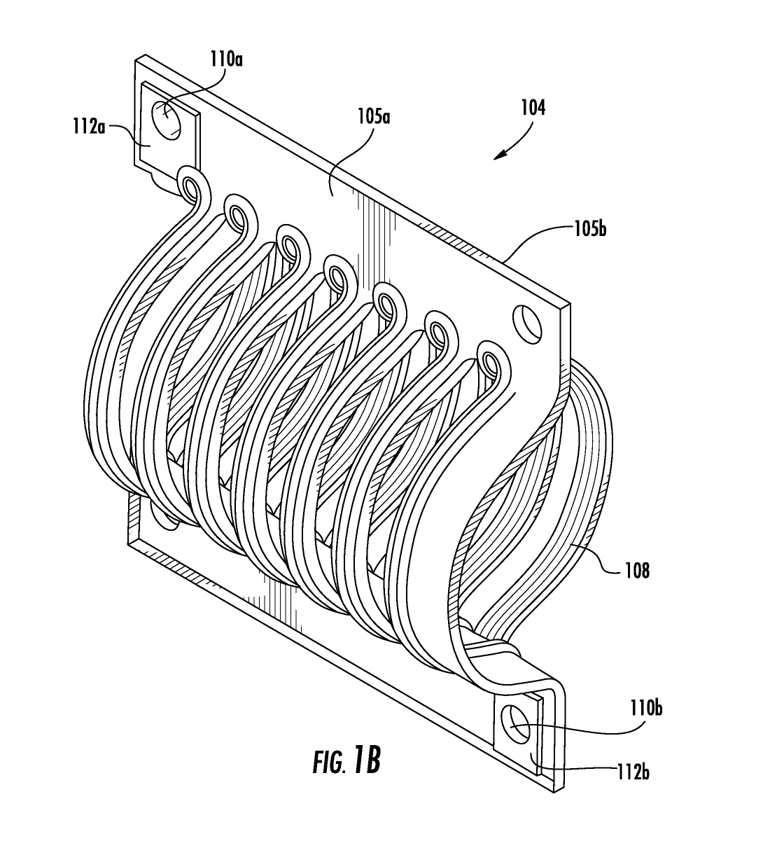

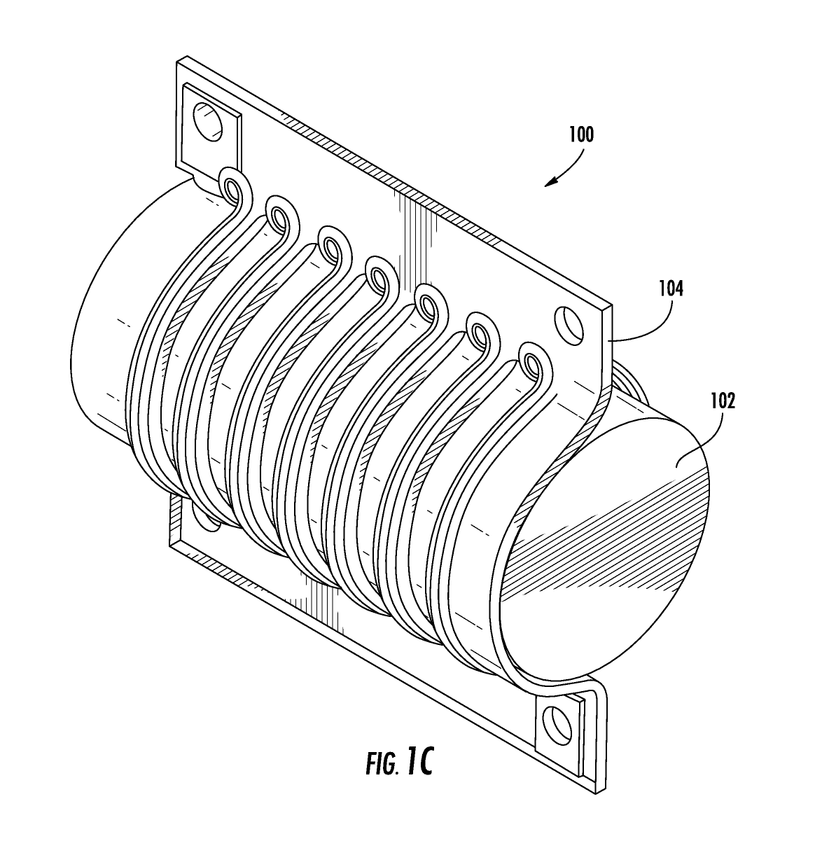

Referring now to FIGS. 1A-1C, an exemplary embodiment of a flexible substrate inductive device 100 is shown and described in detail. FIG. 1A illustrates one such embodiment of a flexible substrate 104 for use with the flexible substrate inductive device shown in FIG. 1C. The flexible substrate comprises a planar surface with a conductive trace 108 shown printed thereon. In addition, a similar conductive trace is also present on the far side of the substrate (not shown). These two (2) conductive traces can be used as, for example, the primary and secondary windings of a transformer device. As illustrated in FIG. 1A, slots 101 are incorporated into the substrate which allows for various ones of the conductive traces to be formed and routed around, for example, a high permeability magnetic core (see e.g., FIG. 1C), thereby Banning the flexible substrate inductive device. In the illustrated embodiment of FIG. 1A, sixteen (16) slots 101 are shown thereby effectively providing for eight (8) turns of windings about the core (FIG. 1C, 102). However, it should be noted that the particular conductive traces illustrated are merely exemplary and therefore depict only one of a potential limitless number of configurations. For example, adjusting the width of the conductive traces, adjusting the spacing between adjacent conductive traces, adjusting the length of the conductive traces, and/or adjusting the number of turns, allows one to alter various characteristics of the underlying inductive device.

In one embodiment, the conductive traces 108 are formed on the substrate utilizing well known printed circuit board (PCB) processing etching techniques of the type known in the art. However, other suitable methods could readily be substituted such as (i.e. spraying, coating, printing, laser direct structuring (LDS), etc.). For example, the conductive traces can be printed or otherwise disposed on the substrate using highly controlled manufacturing processes such that the characteristics of the device, including the spacing and pitch of the windings, can be accurately controlled. Printing these conductive traces as a substitute for wound wiring on a planar surface has economic advantages since traces can be printed faster than they can ultimately be wrapped. Additionally, printing on planar surfaces can be done at high speeds and low cost. Using printing processes provides strategic advantage and economic value. Things such as wire diameter (replaced by printed conductive traces) or wire gaps can be dynamically varied throughout the wrap which can heretofore only be achieved using a printing technique.

The accurate placement of these conductive traces advantageously produces a device with highly consistent performance capabilities as compared with traditional wire wound inductive devices. Additionally, as the underlying substrate is produced utilizing automated processes, as compared to prior art wire wound inductive devices, errors associated with traditional wire wound inductive devices are avoided, thereby resulting in, inter alfa, reduced production costs and improved performance accuracy (e.g. reducing winding errors, eliminating the cost of routing or wrapping wires, rework, etc.). The underlying flexible substitute 103 is comprised of, in one embodiment, a high-performance polymer material, such as polyimide, polyester, polyethylene napthalate, or polyetherimide among others. The use of such a flexible material is advantageous as it enables the substrate to bend or flex during use.

Referring now to FIG. 1B, the printed flexible substrate 104 of FIG. 1A is shown formed for use as a transformer device. Specifically, the printed flexible substrate is formed such that the conductive traces 108 on the substrate form windings that can be routed about a magnetically permeable core (FIG. 1C, 102). As shown in FIG. 1B, a first set of conductive traces are disposed on a first side 105a of the flexible substrate while a second set of conductive traces are disposed on a second side 105b of the flexible substrate. Herein lies yet another advantage of the present embodiment, namely that the conductive traces on the first side 105a of the flexible substrate will spend effectively half their run distance on the external diameter of the formed opening for the inserted core, and the other half of their run distance on the inner diameter of the formed opening for the inserted core. Furthermore, the conductive traces on the second side 105b of the flexible substrate will also spend effectively half their run distance on the external diameter of the formed opening, and the other half of their run distance on the inner diameter of the formed opening for the inserted core. Accordingly, as the windings on the first and second sides of the flexible substrate will each have the same effective winding distance from the inserted core, both windings 108 will result in nearly identical performance. These and other advantages associated with placing the windings such that the effective winding distance of each of the windings is approximately the same are described in co-owned and co-pending U.S. patent application Ser. No. 13/033,523 filed Feb. 23, 2011 and entitled “Woven Wire, Inductive Devices, and Methods of Manufacturing”, the contents of which are incorporated herein by reference in its entirety.

Additionally, while the illustration of two layers of conductive traces is exemplary, it is appreciated that more or less layers of conductive traces could be utilized consistent with the principles of the present disclosure. For example, the flexible substrate could comprise a single layer of conductive traces and accordingly, would only include conductive traces on, for example, one side of the flexible substrate (e.g. on side 105a) in order to form, for example, an inductor. In addition, a single layer could also be implemented on an internal layer of the flexible substrate. Moreover, the flexible substrate could also comprise a multi-layer substrate (e.g. having three (3) or more layers) with the conductive traces disposed not only on the exterior surfaces of the flexible substrate but also on one or more internal conductive layers as well. For example, a 2:1 transformer could be manufactured using the flexible substrate described herein. In other words, the primary windings could be placed on two (2) layers of the flexible substrate while the secondary winding is placed on a single layer of the flexible substrate. Accordingly, the underlying flexible substrate inductive device would ultimately form the 2:1 transformer. As an alternative to the 2:1 transformer described above, this functionality of this transformer can be formed using only two (2) layers of the flexible substrate. For example, the primary windings can be disposed about each of the slots formed in the flexible substrate while the secondary windings are disposed about every two of the slots formed in the flexible substrate. In this fashion, a 2:1 transformer can be formed utilizing only two layers of conductive windings. These and other embodiments utilizing other turns ratios would be readily apparent to one of ordinary skill given the contents of the present disclosure.

Referring again to FIG. 1B, the conductive windings 108 terminate at pads 112a, 112b. These pads can then in be turn terminated to any number of electronic devices including a termination header such as those disclosed headers (whether self-leaded or not) described in co-owned U.S. Pat. No. 7,598,837 filed Jul. 6, 2004 and entitled “Form-less electronic device and methods of manufacturing”; and U.S. Pat. No. 7,598,839 filed Aug. 12, 2005 and entitled “Stacked inductive device and methods of manufacturing”, the contents of which are incorporated herein by reference in their entireties. Furthermore, as illustrated in FIG. 1B, the conductive windings 106 formed by the conductive traces have a first end 112a and a second end 112b with conductive through holes 110a, 110b disposed therein. These through-holes can be terminated onto pin interfaces resident on, for example, an integrated connector module such as that disclosed in U.S. Pat. No. 6,962,511 filed Sep. 18, 2002 and entitled “Advanced microelectronic connector assembly and method of manufacturing”; and U.S. Pat. No. 7,241,181 filed Jun. 28, 2005 and entitled “Universal connector assembly and method of manufacturing”, the contents of which are incorporated herein by reference in their entireties.

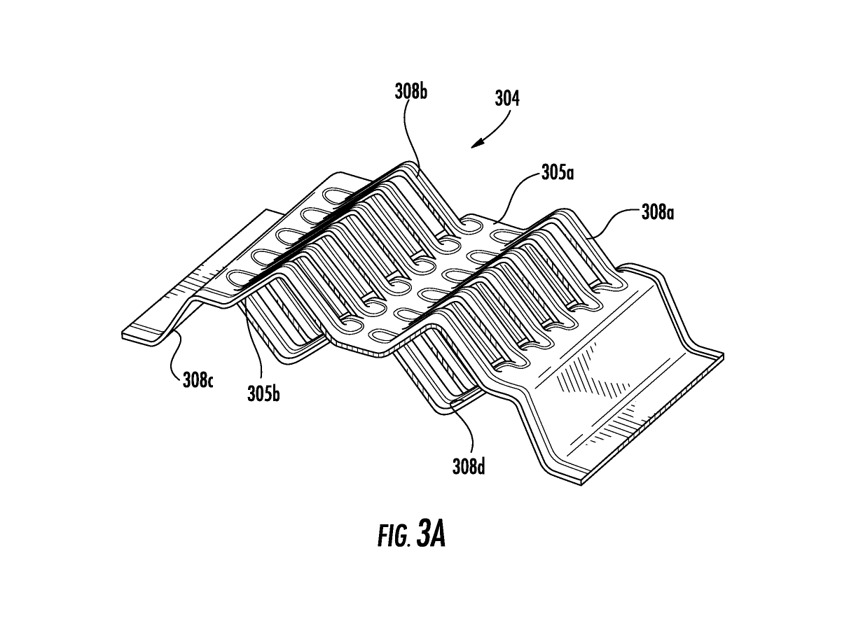

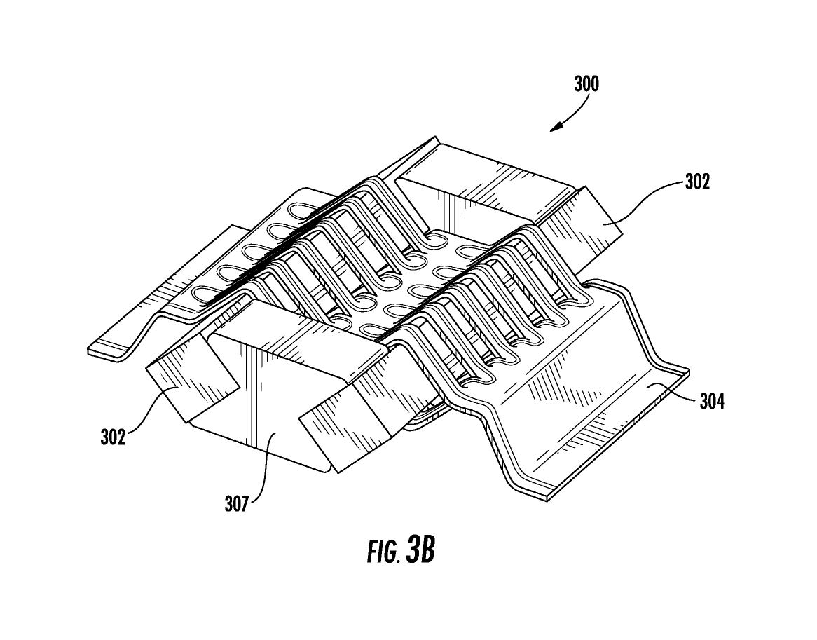

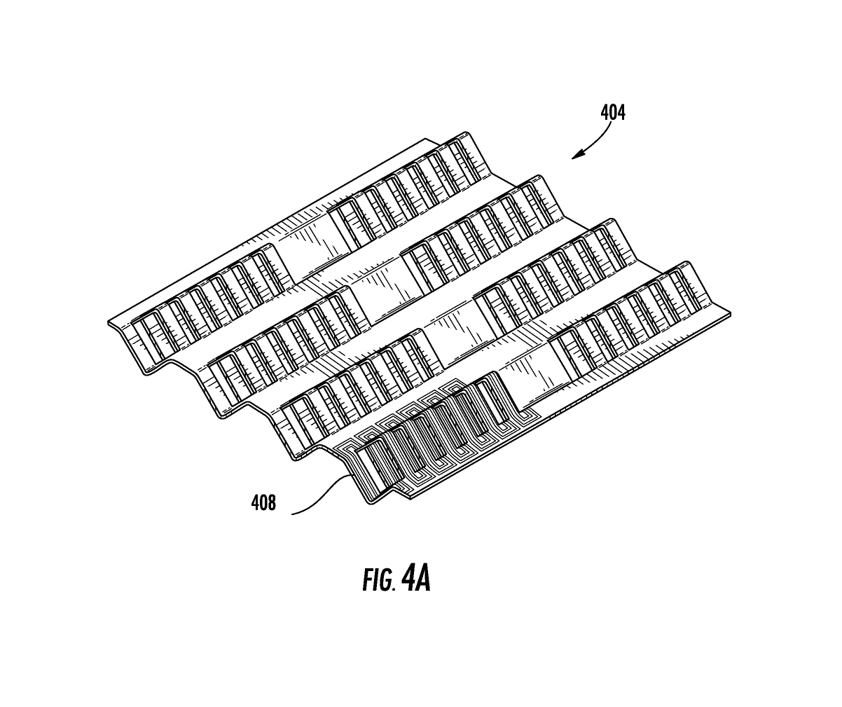

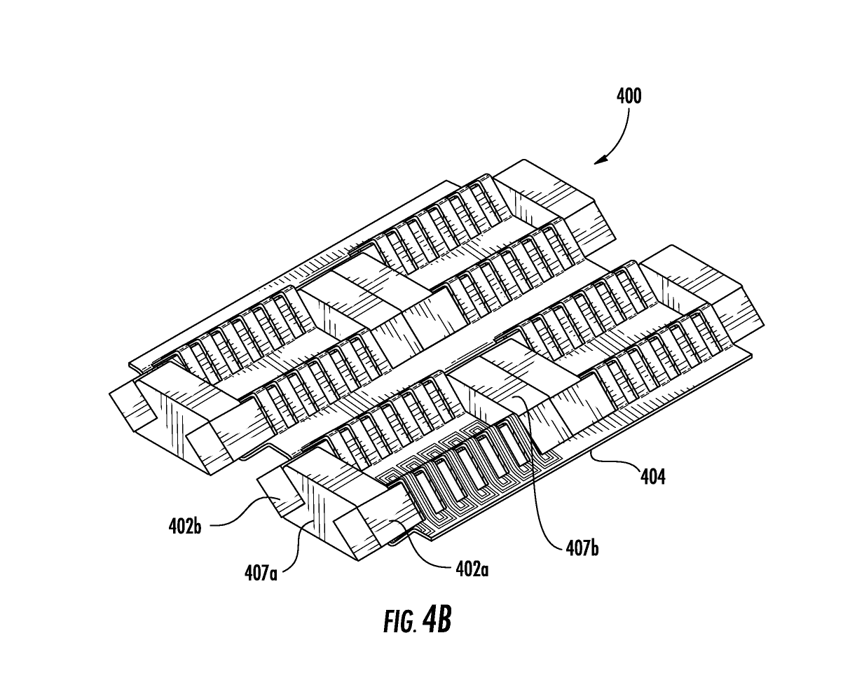

Referring now to FIG. 1C, the exemplary flexible substrate 104 illustrated in FIG. 1B is shown with a core 102 inserted within the flexible windings thereby completing the inductive device 100. The magnetically permeable core 102 is made from, for example, a soft ferrite material or a powdered iron, as is well known in the electronic arts. It should also be noted that although the embodiment of FIGS. 1A-1C is shown as being formed around a cylindrical core, the underlying flexible substrate 104 may form other cross sectional shapes and accommodate other core configurations. For example, an inductive device with a core having a square cross section, such as that shown in FIGS. 3B and 4B, can also be used. Furthermore, other cross sections including without limitation oval, polygonal, and rectangular cross-sections can also be implemented, as well as “dumbell” shaped arrangements (i.e., those with a narrower central region as compared to one or more wider end regions).

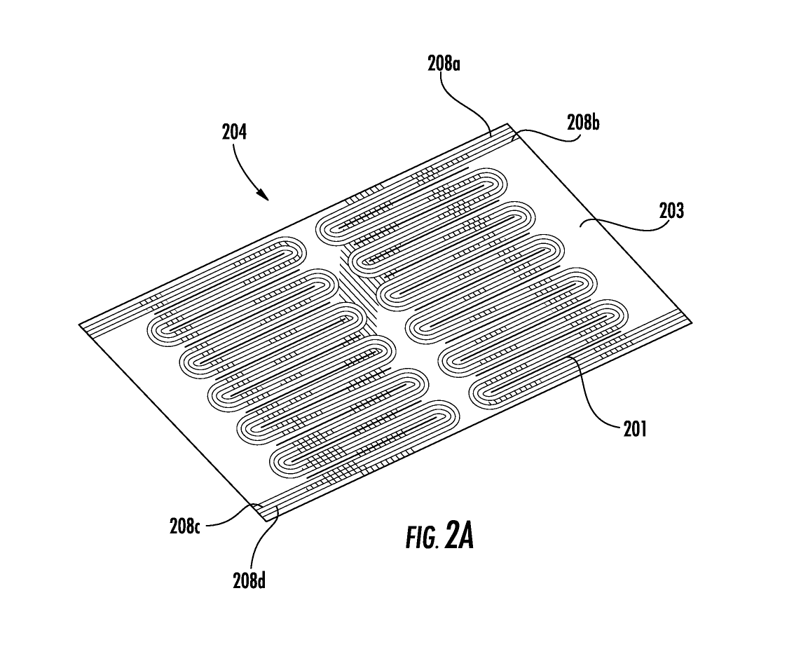

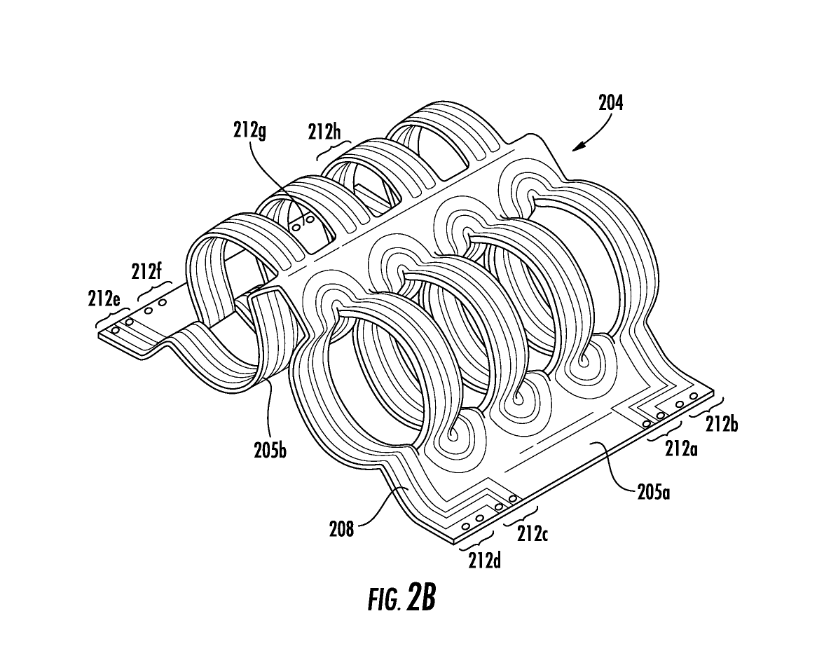

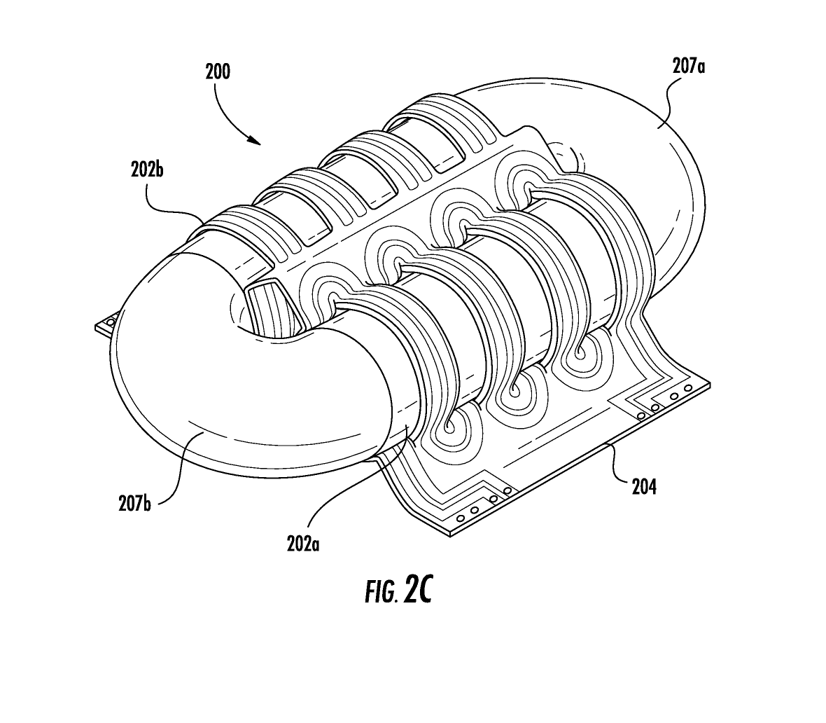

Referring now to FIGS. 2A-2C, an alternative embodiment of a flexible substrate inductive device is shown and described in detail. FIG. 2A illustrates a flexible substrate 204 that is shown in a planar form. Similar to the embodiment discussed at FIGS. 1A-1C, the substrate 204 includes two surfaces upon which windings 208 are deposited. However, unlike the embodiment illustrated in FIGS. 1A-1C, the top surface 203 of the flexible substrate 204 comprises two sets of windings, each set comprised of two separate and distinct sets of windings including a first set of windings 208a, 208b and a second set of windings 208c, 208d. These sets of windings are repeated on the bottom portion of the substrate (not shown).

In addition, similar to that shown in the embodiment of FIGS. 1A-1C, a plurality of slots 201 enable the windings 208a, 208b, 208c, 208d to be routed around a magnetically permeable core (FIG. 2C, 202). In the present illustrated embodiment, the flexible substrate forms two sets of side-by-side windings, though it should be noted that the particular pathways illustrated are merely exemplary and therefore depict only one of a limitless variety of potential configurations.

Referring now to the two sets of windings 208a, 208b in FIG. 2A, in one embodiment, each of these windings are connected and hence form first and second portions of a single winding. Alternatively, each of these windings 208a, 208b will remain separate and distinct from one another thereby forming two separate windings. These and other variations would be readily apparent to one of ordinary skill given the present disclosure.

Referring now to FIG. 2B, the flexible substrate 204 is illustrated in its formed state prior to insertion of, for example, a magnetically permeable core (see e.g., FIG. 2C, 202a, 202b, 207a, 207b). Specifically, both sides 205a, 205b of the flexible substrate can now be seen. In the illustrated embodiment, each set of windings terminate at eight (8) separate sets of terminations 212a, 212b, 212c, 212d, 212e, 212f, 212g, 212h which can be coupled to a termination header such as those disclosed headers (whether self-leaded or not) described in co-owned U.S. Pat. No. 7,598,837 filed Jul. 6, 2004 and entitled “Form-less electronic device and methods of manufacturing”; and U.S. Pat. No. 7,598,839 filed Aug. 12, 2005 and entitled “Stacked inductive device and methods of manufacturing”, the contents of which were previously incorporated herein by reference in their entireties. Alternatively, the conductive windings 208 formed by the conductive traces include through-holes that can be terminated onto pin interfaces resident on, for example, an integrated connector module such as that disclosed in U.S. Pat. No. 6,962,511 filed Sep. 18, 2002 and entitled “Advanced microelectronic connector assembly and method of manufacturing”; and U.S. Pat. No. 7,241,181 filed Jun. 28, 2005 and entitled “Universal connector assembly and method of manufacturing”, the contents of which were previously incorporated herein by reference in their entireties. Furthermore, while a specific winding configuration is shown, it should be noted that the width, spacing, number and/or length of various ones of the windings may be readily adjusted to affect the operational characteristics of the inductive device. These and other variations would be readily apparent to one of ordinary skill given the present disclosure.

Referring now to FIG. 2C, an inductive device 200 comprised of four (4) separate core components 202a, 202b, 207a, 207b that are inserted into the printed windings located on the flexible substrate 204. The four (4) separate core components are assembled so as to form a magnetically permeable core which, in the illustrated embodiment, forms a closed magnetic path (e.g. an elongated toroidal shape). While the illustrated toroidal closed magnetic path shown is exemplary, it is recognized that a variety of core shapes (e.g. rectangular, etc.) of the type well known in the art could be easily substituted in place of the core illustrated. Furthermore, while the illustrated embodiment illustrates four (4) separate core pieces that make up the underlying core structure for the inductive device, more or less core pieces could be readily substituted with the illustrated four (4) core pieces merely being exemplary.

Referring now to FIGS. 3A-3B, an alternate embodiment using the configuration generally shown with regards to FIGS. 2A-2C is shown and described in detail. Specifically, FIG. 3A illustrates a flexible substrate 304 having two sets of windings 308a, 308b disposed on the top surface 305a of the substrate and two sets of windings 308c, 308d disposed on the bottom surface 305b of the substrate. FIG. 3B illustrates an inductive device 300 showing the substrate 304 of FIG. 3A with a closed magnetic path core disposed therein. Specifically, the closed magnetic path core in the illustrated embodiment includes two (2) square cross-sectional cores 302 connected with two (2) connecting core portions 307 which collectively close the magnetic path for the inductive device. While the illustrated embodiment illustrates four (4) separate core pieces that make up the underlying core structure for the inductive device, more or less core pieces could be readily substituted with the illustrated four (4) core pieces merely being exemplary.

Referring now to FIGS. 4A-4B, yet another alternative embodiment of the present disclosure is shown and described. Specifically, FIG. 4A shows a perspective view of the inductive apparatus 400 including windings 408 for four (4) separate and distinct inductive devices implemented in a two-by-two (2×2) array. While a two-by-two (2×2) array is shown, it is appreciated that such an array configuration is merely exemplary and other array types could be readily substituted. As shown in FIG. 4A, only a single winding 408 is shown, however it is appreciated that similar windings to that shown could be readily replicated on other portions of the flexible substrate.

Referring now to FIG. 4B, the two-by-two (2×2) array configuration of the illustrated inductive device 400 is now more readily apparent. Specifically, the inductive device is comprised of four (4) closed magnetic path ferrite cores, each of the ferrite cores consisting of two (2) rectangular portions 402a, 402b that are coupled together via end core pieces 407a, 407b similar to that shown with respect to FIGS. 3A-3B. While the illustrated embodiment illustrates four (4) separate core pieces that make up the underlying core structure for the inductive device, more or less core pieces could be readily substituted with the illustrated four (4) core pieces merely being exemplary.

Methods of Manufacture—

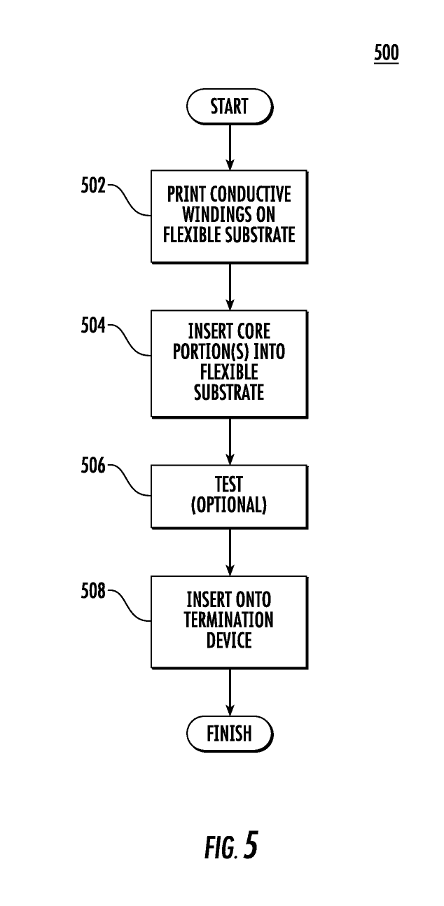

Referring now to FIG. 5, one exemplary embodiment of the method for manufacturing 500 a flexible substrate inductive device is shown and described in detail. The flexible substrate is comprised of, in one embodiment, a high-performance polymer material, such as polyimide (“PI”), polyester, polyethylene napthalate (“PEN”), or polyetherimide. Flexible substrates can also be formed from paper cellulose pulp material or other wood-based materials as well.

At step 502, the conductive windings are printed on the flexible substrate. These conductive windings may be printed using digital printing such as: (1) thermal inkjet; (2) piezo inkjet; (3) micro piezo inkjet; (4) bubble jet; or using analog printing technologies including: (1) screen printing; (2) gravure printing; (3) flexo printing; (4) engraving printing; (5) pad printing; (6) rotary printing; (7) rotary screen printing; (8) and stencil printing, among others. In addition, the conductive windings may be printed using a process known as aerosol jetting, wherein the process uses a mist generator that atomizes a source material that is refined and deposited (e.g. Optomec). Other possible variations include: (1) maskless mesoscale materials deposition; (2) fluid and material dispensing systems using auger, head over valve, piezo, valve, needle, screw, cavity, conformal coaters, and pumps.

Additionally, printing and processes similar to printing are also envisioned. These processes include: (1) micro contact printing; (2) nano-imprint lithography; (3) etching/engraving including on conductive foils; (4) Laser Direct Structuring (LDS); and (5) spray and stencil techniques. The etching and engraving process described above means removing material via light (e.g., laser) or via a chemical reduction process. In addition, any print or etch process of print thin films previously deposited and/or the substrate itself includes both wet etching and dry etching. Printing or etching can apply to either the positive or negative image or both. Base foils include, but are not limited to, electrodeposited copper, rolled copper, and various other alloys. Base materials include, but are not limited to steel, copper, nickel, and other various alloys. Etching can be also referred to as photo chemical milling, metal etching, chemical machining, or photo fabrication. Both one and two sided printing or etching is envisioned.

Conductive inks can also be used in the printing of seed layers for electroplating processes. Seed and grow technology generally involves printing a layer, and then electroplating another layer, such as a metal (copper, for example) onto the printed layer. Plating can then be used to decrease electronics cost.

Other print fluids include, but are not limited to, conductors, semiconductors, dielectrics, and insulators. Both organic and inorganic materials can be used. Printing fluids can take the form of a liquid, for solution, dispersion or suspension. The patterns can be made from electrically conductive materials or particles with a metallic base (e.g. silver, copper, gold, aluminum, alloys and/or mixtures of these elements, micron or nano particles of these elements, and any other suitable elements). These are printable in the general sense using inks, pastes, polymers, or printable pastes and/or inks based on conductive polymers, conductive oxides, like iron oxide, ITO or aluminum zinc oxide, carbon nanotubes or graphene.

In one exemplary embodiment, the flexible substrate is comprised of a polyimide film having a thickness ranging from about 0.0005 to 0.005 inches (0.5 to 5 mils). The use of polyimide is advantageous in that polyimide films have an excellent balance of electrical, mechanical and thermal properties. A metal foil (for example, copper) is then subsequently etched onto the underlying flexible substrate. These metal foils may include, for example, electrodeposited copper, rolled copper, and various other alloys. Base materials can include, but are not limited to steel, copper, nickel, and other various alloys.

While the use of a polyimide film is exemplary, other materials can readily be substituted for use with printing processes. These substrates suitable for printing can be foamed of, for example, a paper cellulose pulp material or alternatively with a plastic material. The plastic material can include polyethylene terephthalate (“PET”), polyethylene naphthalate (“PEN”), polycarbonate (“PC”), acrylonitrile butadiene styrene (“ABS”), as well as any high-density polyethylene (“HDPE”) and low-density polyethylene (“LDPE”) rigid and semi-rigid plastics. When printing is chosen, the underlying substrate may also include pre- and post-treatment processes including thermal, infrared, corona, plasma (e.g. flame, chemical or atmospheric) or air ventilation using concentrations of gases such as oxygen, flame and etching, priming, or electrostatic treatment techniques. These treatments may also apply to conductive foils that have been printed or etched. Similar print treatments can provide additional mechanical or dielectric properties and include, without limitation, molding, over-molding or injection molding the substrates which are printed, insulated and/or plated.

Once printed using any of these pastes, inks or fluids, the underlying printed material must be cured. These printed pastes, inks or fluids can be cured using, for example, thermal oven based curing, infrared based curing, UV based curing, and microwave based curing, or may be flash cured using photonic curing systems. Additionally, these printed substrates can be cured using chemical curing or evaporation processes with the process of curing occurring under vacuum and/or thermal vacuum oven curing.

Subsequent to flexible substrate printing, the printed conductive traces often need to be cured. These pastes, inks or fluids can be cured using thermal oven based curing, infrared based curing, ultraviolet (UV) based curing, microwave based curing, or flash cured using photonic curing systems. Additionally, these printed conductive traces can be cured using chemical curing or evaporation processes. The process of curing can take place under vacuum and/or using thermal vacuum oven curing.

At step 504, the flexible substrate if formed into its final inductive device form and one or more core portion(s) are inserted into the flexible substrate thereby forming the underlying flexible substrate inductive device. For example, in one embodiment, once printed the substrate can be shaped and/or rolled and/or folded with or without a cover coating in a three-dimensional (3D) shape. This is done via typical 3D forming techniques that include heat or pressure sufficient to cause the substrate to set in the desired 3D shape. Termination to the printed conductive material is done by integrating the carrier material with adhesives, welding (e.g., laser, exothermic bonding, thermite, ultrasonic, arc, resistance, capacitive charge), clips, pogo pins, springs, snap fits, or soldering, or other joining methods. Additionally, certain areas may use pads applied by any of the printing methods described previously (site document number index).

At step 506, the flexible substrate inductive device is optionally electrically tested in order to ensure that the device meets various electrical design parameters.

At step 508, the flexible substrate inductive device is inserted onto a termination device. In one embodiment, the termination device comprises an injection molded polymer header of the type known in the electronic arts. In an alternative embodiment, the flexible substrate inductive device is inserted into an integrated connector module thereby forming the underlying magnetic circuitry present within many of these integrated connector modules such as those described in, for example, U.S. Pat. No. 6,962,511 filed Sep. 18, 2002 and entitled “Advanced microelectronic connector assembly and method of manufacturing”; and U.S. Pat. No. 7,241,181 filed Jun. 28, 2005 and entitled “Universal connector assembly and method of manufacturing”, the contents of which were previously incorporated herein by reference in their entireties.

It will again be noted that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein,

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

What is claimed is:

1. A flexible substrate inductive device, comprising:
a flexible polymer film having a plurality of conductive traces disposed thereon; and
a ferrite core;
wherein the flexible polymer film is shaped so that the plurality of conductive traces forms one or more windings, the ferrite core disposed such that its use in combination with the one or more windings forms the flexible substrate inductive device.

2. The flexible substrate inductive device of claim 1, wherein the flexible polymer film comprises two surfaces with the one or more windings disposed on each of the two surfaces.

3. The flexible substrate inductive device of claim 2, wherein the one or more windings comprises two separate and distinct sets of windings, the two separate and distinct sets of windings comprising a primary winding and a secondary winding.

4. The flexible substrate inductive device of claim 3, wherein the primary winding is disposed on a first surface of the flexible polymer film and the secondary winding is disposed on a second surface of the flexible polymer film.

5. The flexible substrate inductive device of claim 3, wherein the flexible polymer film comprises a plurality of slots, the slots configured to enable the flexible polymer film to be formed about the ferrite core.

6. The flexible substrate inductive device of claim 5, further comprising a plurality of interface locations disposed on the flexible polymer film.

7. The flexible substrate inductive device of claim 6, wherein the plurality of interface locations are configured to interface with a printed circuit board disposed within an integrated connector module.

8. The flexible substrate inductive device of claim 6, wherein the plurality of interface locations are configured to interface with a termination header.

9. The flexible substrate inductive device of claim 1, wherein the flexible polymer film comprises a first surface having two separate and distinct windings disposed thereon.

10. A flexible substrate inductive device, comprising:
a flexible substrate comprised of at least two rows of slots disposed therein; and
a ferrite core;
wherein the flexible substrate comprises a plurality of windings with a set of windings disposed about each of the rows of slots.

11. The flexible substrate inductive device of claim 10, wherein the at least two rows of slots comprises a pair of rows and the ferrite core is disposed within each of the pair of rows.

12. The flexible substrate inductive device of claim 11, wherein the ferrite core comprises a plurality of ferrite core component portions.

13. The flexible substrate inductive device of claim 12, wherein the plurality of ferrite core component portions are joined together to form a closed magnetic path.

14. The flexible substrate inductive device of claim 13, wherein the plurality of windings are disposed on at least two surfaces of the flexible substrate.

15. The flexible substrate inductive device of claim 14, wherein at least two windings of the plurality of windings are disposed on a first of the at least two surfaces of the flexible substrate.

16. A method of manufacturing a flexible substrate inductive device, comprising:
printing one or more conductive windings onto a two-dimensional flexible substrate;
forming the two-dimensional flexible substrate into a three-dimensional form; and
inserting a core portion into the three-dimensional flexible substrate form.

17. The method of manufacturing the flexible substrate inductive device of claim 16, wherein the act of printing the one or more conductive windings comprises printing the one or more conductive windings onto two surfaces of the flexible substrate.

18. The method of manufacturing the flexible substrate inductive device of claim 16, further comprising disposing a plurality of slots onto the flexible substrate, the slots configured to enable the flexible substrate to be formed into the three-dimensional form.

19. The method of manufacturing the flexible substrate inductive device of claim 18, further comprising disposing a plurality of interface locations onto the flexible substrate.

20. The method of manufacturing the flexible substrate inductive device of claim 19, further comprising disposing the flexible substrate onto a printed circuit board that is to be disposed within an integrated connector module.
